(19) United States
(12) Patent Application Publication
(10) Pub. No.: US 2014/0284428 A1
(43) Pub. Date: Sep. 25, 2014

(54) Method and apparatus for the thermal protection of a space vehicle.

(71) Applicant: Alexander Anatoly Khmeloev, Saint Petersburg (RU)

(72) Inventor: Alexander Anatoly Khmeloev, Saint Petersburg (RU)

(21) Appl. No.: 13/847,573

(22) Filed: Mar. 20, 2013

(51) Int. Cl. B64G 1/58

(52) U.S. Cl. CPC B64G 1/58
USPC 244/171.8

(57) ABSTRACT

The essence of the invention is a method and apparatus for thermally protecting the external surface of the structure of a space vehicle during atmospheric reentry. The method, in detail, uses a recently discovered fundamental electrodynamic combustion mechanism for alkali metals to burn the metal onto the surface of the outer wall of the vehicle. In this mechanism, a static electric field that is always inherent to the burning alkali metal surface interacts electrodynamically with the ionized particles streaming behind the atmospheric front shock wave that propagates in front of the vehicle such that the electrodynamic Lorentz force deflects the particles perpendicularly away from the original direction of the ionized atmospheric flow. Thus, convective heat flux into the vehicle's structure is prevented.

An apparatus is also presented for coating the alkali metal onto the porous outer wall of the vehicle structure via transpiration from the interior of the liquid lightweight alkali metal.

This Nonprovisional (Utility) Patent Application follows the Provisional Patent Application No. 61/621,472 filed on Apr. 7, 2012 and titled “Method and tool for thermal protection of a space vehicle”.

### FIELD OF THE INVENTION

The present invention is related to the thermal protection systems of spacecrafts and more particularly to reusable vehicles that enter a planet's atmosphere at high velocity.

### DESCRIPTION OF THE RELATED ART

Spacecraft reentry into the Earth's atmosphere causes strong heating of the outer skin of the spacecraft. The temperatures of particularly critical areas of the skin can reach from 1,000 to 3,000 degrees Celsius. The elevated heating results from the conversion of the kinetic energy of the atoms and molecules of the atmosphere into heat due to friction between these atoms and molecules and the spacecraft skin. In addition, a shock wave is created in front of the spacecraft containing dissociated and/or ionized atoms and molecules. These atoms and molecules recombine at the spacecraft skin, releasing heat. Consequently, the manned capsules flown by the US and Russia, for example, have used ablative heat shields to protect the capsule from heating upon reentry (see, for instance, U.S. Pat. No. 3,720,075 and German Patent No. DE-69621968T2). These heat shields are reliable but can only be used once, preventing their use in a fully reusable spacecraft. In addition, the mass of the ablative heat shield can significantly contribute to the total mass of the reentry capsule.

In contrast to spacecraft, the US-Space Shuttle Orbiter uses high temperature ceramic tiles as a reusable thermal protection system (see, e. g., U.S. Pat. Nos. 6,955,853 and No. 7,845,354 and German Patent No. DE-202005013162U1), but the the repair process between flights is very expensive.

A long-term thermal protection system (TPS) for space vehicles requires some means of active cooling, such as backside convective cooling or transpiration. A backside convective cooling TPS includes a thermal conductive skin that transfers atmospheric heat to a liquid coolant. However, this method of skin thermal protection significantly increases the complexity and mass of the TPS because the absorbed coolant thermal energy must be expelled at a heat sink (see, e.g., German Patent No. DE-4130693C1).

A transpiration TPS is the most thermally efficient active cooling system available (see, e.g., U.S. Pat. Nos. 3,138,009; No. 3,793,861; No. 4,949,920; No. 7,275,720 and patent application Ser. No. 11/301,573). This approach is similar to that of the ablative system, but instead of an ablative medium that vaporizes to block convective heat transfer, a transpiration medium is injected through pores of the skin to maintain the surface (skin) at a cool temperature.

However, apart from these benefits, a transpiration TPS also has disadvantages. The main drawback is that the low density of the most effective coolant, hydrogen, can result in an unacceptably large volume/mass of the coolant tank while providing thermal protection for the spacecraft.

The nearest existing active skin cooling method to the present invention, i. e., the invention's prototype, is German Patent No. DE-10007372A1, which is based on the action of electrostatic, magnetic, or electromagnetic fields. The effect of such thermal protection is that the electrostatic or magnetic fields cast aside the charged plasma particles, i.e., the electrons and ions that form upon the reentry of the space vehicle into the atmosphere. The disadvantage of this system is that a massive electric generator as a power supply and fuel is required for the system to function.

The objective of the present invention is to overcome the drawbacks of previous TPSs and, especially, to widen the range of the reentry velocities of the space vehicles that can be used in future missions to the far planets of the Solar system.

### BRIEF SUMMARY OF THE INVENTION

The invention is based on a physical phenomenon that was discovered by the present author, which was subsequently reported in a paper by the same author (2012) (see Information Disclosure Statement Form, Part 2).

The essence of the phenomenon is based on the proven existence of a layer (or a cloud) of electrons that are associated with the surface of any piece of metal, including the alkali metals. Because the alkali metals have the greatest surface electron cloud of all metals, this invention uses a coating of an alkali metal layer that is formed by transpiration through the vehicle's outer skin.

The author has confirmed this phenomenon by performing experiments on the combustion of an alkali metal spray, where the splitting of spectral lines was observed. Spectral line splitting, which is referred to as the Stark effect, indicated the presence of a strong static electric field at the combustion zone of the alkali metal, The high electric field near the flame zone was manifested as an interaction between the associated surface electron cloud and the mobile free charged particles (primarily electrons) of the combustion zone (see the section titled “Brief description of the phenomenon”).

During the space vehicle reentry into the atmosphere, atoms and molecules of the atmosphere dissociate and/or ionize while moving through the shock wave; consequently, these charged particles also interact with the surface electron cloud according to the Lorentz law. As the thickness of the associated surface electron cloud, i.e., the total charge of the cloud, is known to exceed the total charge of the mobile free electrons at the alkali metal flame zone by approximately four orders of magnitude, the electron cloud has an effect on the free electrons of the heated ionized air that is behind the shock wave and above the alkali metal flame zone. In other words, the electrons associated with the surface not only affect the mobile free electrons in the alkali metal combustion zone but also the free electrons behind the shock wave that are cast aside due to the action of the electrodynamic Lorentz forces (see “Description of the drawings”). Because the mobile free electrons are inseparably linked with the corresponding positive ions (of the alkali metal or the air), the latter are cast aside after the electrons.

Thus, such a fundamental electrodynamic method of thermal protection can sufficiently decrease the convective heat flux into the outer skin and the structure of the space vehicle during reentry into the atmosphere.

### BRIEF DESCRIPTION OF THE FUNDAMENTAL PHENOMENON

The present invention is based on a fundamental electrodynamic combustion mechanism of an alkali metal, specifically involving an alkali metal spray that has been described in the aforementioned paper (2012) (see Information Disclosure Statement Form, Part 2).

The combustion mechanism, as described, involves the interaction between two electron layers near the burning surfaces of the alkali metal droplets of the spray (see “Detailed Description of the Invention”).

The first electron layer, namely, the electron layer associated with the surface, forms on the metal surface as the outer part of a double electric layer (a dipole layer). The free electrons arising from the vapor surrounding the droplets of the spray forms a second electron layer, i.e., a layer of mobile electrons. The electrostatic interactions between the two electrical layers (the layer associated with the surface and the mobile layer) result in an immense increase in the vapor zone surrounding the droplet, i.e., the flame stand-off distance.

Thus, a dynamic equilibrium is set up within the combustion zones of the burning droplets between the internal electrical Coulombic repulsive forces of the negative ions (consisting primarily of oxygen atoms, molecules, and hydroxyl-groups) and the external pressure of neutral oxygen molecules, atoms and hydroxyl-groups that are diffusing radially inward from the outer regions (against the outward flow of the combustion products).

This dynamic equilibrium of forces has been shown to correspond to a steady state of the electric field between two charged electron layers, i.e., as in the vapor surrounding the burning droplets, whereas the action of this electric field on emitting atoms from the flame zone produces the so-called Stark effect.

### BRIEF DESCRIPTION OF THE DRAWINGS

For a better understanding of the claimed invention some variants of the invention embodiment are described with the references to the following drawings.

FIG. 1 shows a diagram explaining the principles of the electrodynamic combustion mechanism that acts on the surface of an alkali metal droplet.

FIG. 2 shows schematically the action of the electrodynamic TPS for the reusable vehicle during its atmospheric reentry when both oxygen and nitrogen can be dissociated and ionized passing through the shock wave.

FIG. 3 shows schematically a cross-sectional view and action of the electrodynamic transpiration-based TPS.

### DETAILED DESCRIPTION OF THE INVENTION

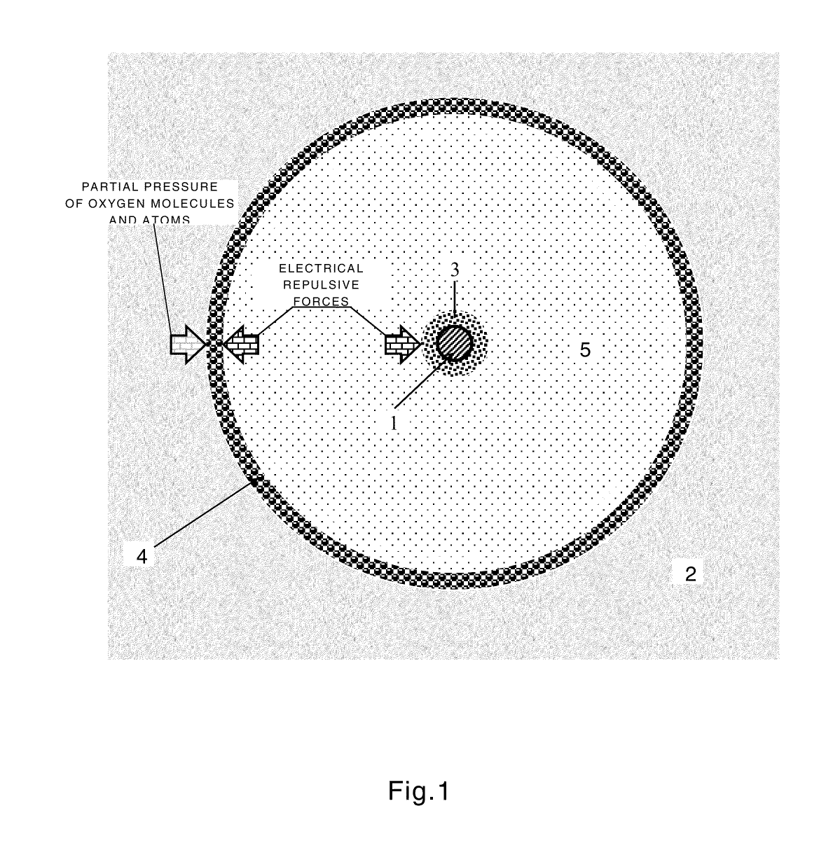

FIG. 1 (1/3) shows a diagram explaining the principles of the electrodynamic combustion mechanism that acts on the surface of a burning alkali metal droplet (1). It is a schematic in which the vapor-phase combustion process of the metal vapor (5) in gaseous combustion products of the fuel in oxygen (2) is shown.

The burning spray of the alkali metal was generated by means of injection and self-ignition of the liquid alkali metal into a fluid jet from the nozzle of the combustion chamber (see Information Disclosure Statement Form, Part 2). The fluid jet consisted of the products of the combustion of the fuel (kerosene) in oxygen (2).

This drawing shows the effect of the electrostatic Coulomb forces between two electron layers, the layer associated with the metal surface (fixed) (3) and the free electron layer, in the roughly spherical flame zone (4) surrounding the droplet. The fixed electron layer consists of a quasi-free electron gas of the metal that is bound to the metal surface in the form of an electron cloud (3).

Free electrons that arise in the alkali metal vapor (5) due to the radiation of resonance quanta from the flame zone (4) are ejected through the fixed surface electrons (3) of the metal droplet (1) towards the flame zone (4). This process is facilitated by the positive ions paired with the free electrons, which are attracted and neutralized through the surface electron cloud (3). In other words, the equal and opposite motion of the positive and negative particles due to electrostatic Coulomb forces in the vapor surrounding the droplet causes the free electrons to be expelled toward the flame zone (4), while the positive ions are attracted to the electron cloud associated with the surface (3). Provided that the positive metal ions are neutralized by the surface electron cloud (3) to form neutral atoms, the free electrons move readily to the flame zone (4) where they are absorbed first by oxygen molecules and atoms and hydroxyl-groups OH of the combustion products (2) (which have a high electron affinity). The emergence of negative ions in the combustion zone (4) results in a significant increase in the flame stand-off distance due to the Coulomb interactions between these ions and the fixed surface electrons (3) of the droplet (1).

Found that the charge of the surface (fixed) electron layer (3) is about four orders-of-magnitude larger than the charge of free electrons in the vapor cover (see Information Disclosure Statement Form, Part 2).

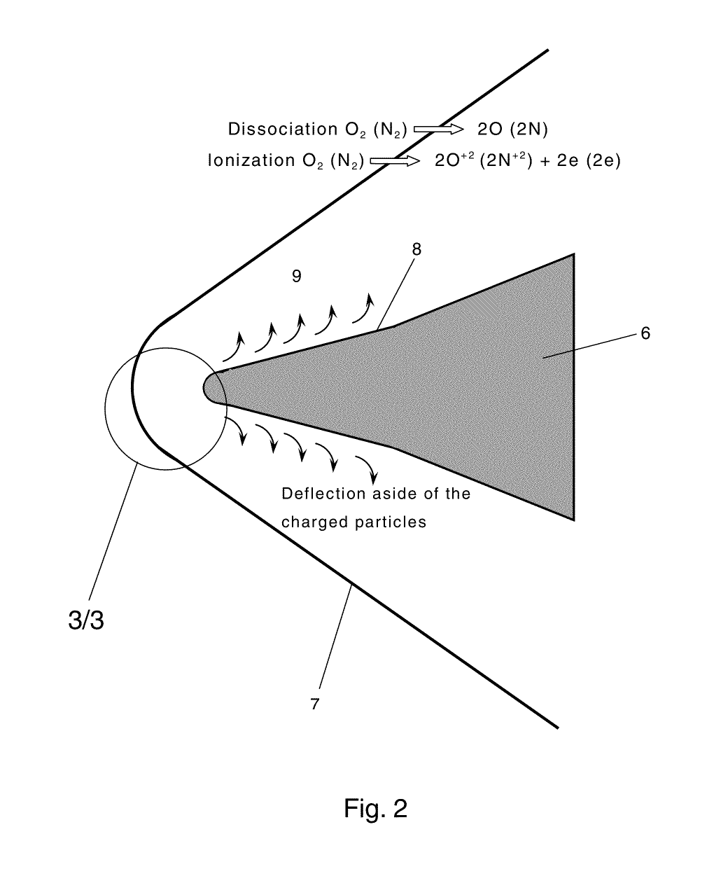

FIG. 2 (2/3) depicts the reentry of the reusable space vehicle with a blunt heat shield (6) into the atmosphere. The shock wave (7) caused through its high velocity motion is located in front of the heat shield. Both oxygen and nitrogen of the atmosphere can be dissociated and ionized when passing through the shock wave (7). These fast-moving atmospheric electrons and ions (9) would interact according to the Lorentz law with the surface electron layer of the mentioned heat shield. The Lorentz-interaction would manifest itself through deflection aside of the moving charged particles of the atmosphere, what would reduce the heating of the outer skin (8).

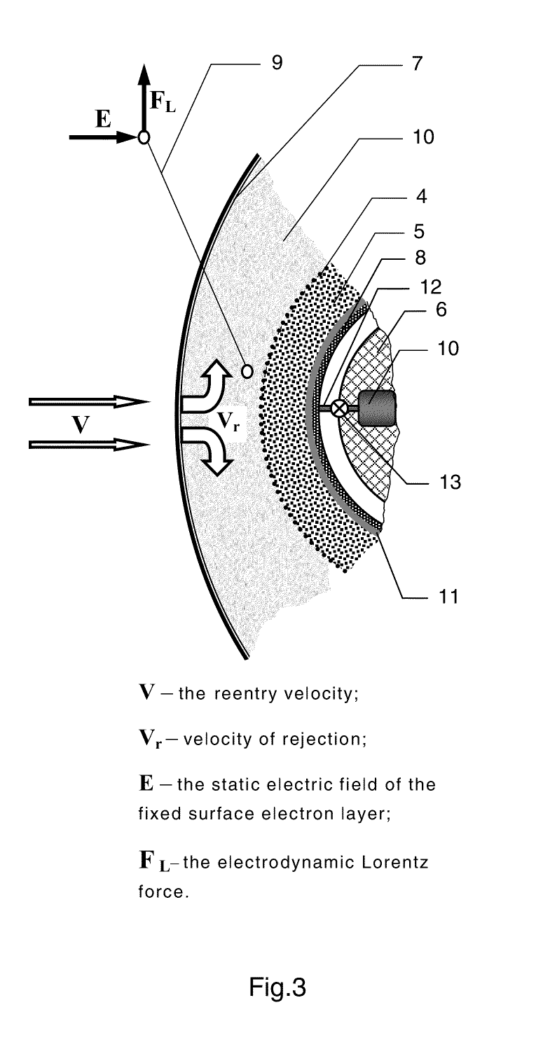

It can be argued, as the surface electron layer of the burning alkali metal piece exceeds as mentioned above about four orders-of-magnitude the charge of all free electrons in the vapor cover of the alkali metal, i.e. the surface electrons of the heat shield would certainly Lorentz-interacting with moving electrons and ions of the atmosphere (see FIG. 3).

These heat shields, i.e., the TPS, must protect all thermally loaded parts of the outer skin (8) and structure of the vehicle (6) from atmospheric heating.

FIG. 3 (3/3) shows a cross-sectional view of the transpiration-based TPS during atmospheric reentry. The drawing shows the vehicle structure (6), which is protected thermally by the TPS that consists of the following components: a porous outer skin (8); a transpiration storage reservoir (10) to store the liquid alkali metal; a conduit (12) to conduct the liquid alkali metal to the porous outer skin; an alkali metal surface layer (11) that transpires through the porous skin; and a valve (11) to isolate the storage alkali metal reservoir (10) from the heat shield surface. The drawing also shows the following components: the shock wave (7); the ionized shock layer (9) of ionized air behind the shock wave (7); an alkali metal vapor layer (5) emerging above the alkali metal layer; and the surface combustion zone (4) of the alkali metal vapor.

The following vectors are indicated by arrows in the drawing: the electrostatic field vector E; the Lorentz force vector F_{L} that casts aside the electrons and ionized atoms (9) of the air; and the relative velocities of the atoms and molecules of the air before (V) and after (Vᵣ) the shock wave.

The TPS acts as follows: When the reusable space vehicle reenters the atmosphere the valve (13) is opening and the liquid alkali metal from the transpiration storage reservoir (10) through the conduit (12) and the porous outer skin (8) penetrates to the outer side of the latter as the layer of alkali metal (11). Here the alkali metal (11) self-ignites due to the atmospheric heating so that the action of the electrodynamic combustion mechanism arises as cited above.

When heat gain to the outer skin (8) of the reusable space vehicle (6) drops the valve (13) to isolate the storage alkali metal reservoir (10) from the porous outer skin (8) is closed so that the TPS is out.

What is claimed is:

1. A method and apparatus for the thermal protection of the skin and the underlying structure of a space vehicle from heating upon atmospheric reentry. The method comprises the following steps: first, thermally high loaded areas of the vehicle skin are coated with a material layer consisting of homogeneous lightweight alkali metals or alkaline metal alloys, which is heated up to self-ignition followed by surface burning; next, the skin is thermally protected by the action of natural electrodynamic Lorentz forces generated by electrons that are associated with the surface of the burning alkali metal layer casting aside the mobile charged particles (electrons and ions) of ionized air.

2. The method according to claim 1, wherein the alkali metal layer that coats the heated areas of the skin is being continuously burnt out and is also being continuously re-formed due to transpiration of the liquid alkali metal through the porous outer skin of the vehicle.

3. The method according to claim 2, wherein the lightweight homogeneous alkali metal or alkaline metal alloy transpires through the porous outer skin.

4. The method according to claim 2, wherein said the lightweight homogeneous alkali metal is lithium.

5. The method according to claim 2, wherein said the alkaline metal alloy is a lithium-sodium-eutectic.

6. The thermal protection apparatus for the realization of the method according to claim 1 comprises the following components: a liquid alkali metal reservoir; a porous outer skin that ensures the transpiration flow of the liquid alkali metal; a pressurization system, which forces the transpiration flow through the porous outer skin of the vehicle; a conduit to conduct the liquid alkali metal to the porous outer skin; and a valve to isolate the reservoir from the heat shield surface.
